(19) United States
(12) Patent Application Publication
(10) Pub. No.: US 2007/0287651 A1
(43) Pub. Date: Dec. 13, 2007

(54) Bleaching compositions

(75) Inventors: Luca Sarcinelli, Cerveteri (IT); Annabelle Mayeux, Pavona (Rome) (IT); Vincenzo Guida, Rome (IT)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Procter & Gamble Company

(21) Appl. No.: 11/811,039

(22) Filed: Jun. 8, 2007

(30) Foreign Application Priority Data
Jun. 8, 2006 (EP) 06 115 136.1

(51) Int. Cl. C11D 3/395

(52) U.S. Cl. 510/302

(57) ABSTRACT

The present invention relates to a composition suitable for treating soiled fabrics comprising a hypohalite bleach, a brightener and a latex. The present invention also relates to a process of bleaching a fabric with said liquid aqueous composition.

### FIELD OF THE INVENTION

The present invention relates to bleaching compositions, in particular to hypohalite bleaching compositions, suitable for use in various laundry applications.

### BACKGROUND OF THE INVENTION

Bleaching compositions are well-known in the art. Amongst the different bleaching compositions available, those relying on bleaching by hypohalite bleaches such as hypochlorite are often preferred, mainly for performance reasons, especially at lower temperature. However, there are some limitations to the convenience of hypohalite bleaches. In particular, a problem encountered with the use of hypohalite based-compositions, like hypochlorite-based compositions, is the resulting yellowing of the fabrics being bleached and moreover, the stability problem of this kind of compositions. To solve the yellowing problem, brighteners have been added to hypohalite bleach-based compositions. However, when such brighteners is incorporated, the resulting composition generally shows even worse chemical stability upon ageing of the composition, resulting thereby in low whiteness performance of the composition when used in any laundry application after prolonged periods of storage. Indeed, upon prolonged storage periods the brighteners may be decomposed by the hypohalite bleach present in such a liquid hypohalite bleach-based composition, and thus may lose its whitening potential. Moreover, this brightener decomposition can be accelerated by product exposure at high temperature or by raw material impurities.

It is therefore an object of the present invention to provide a hypohalite bleach-containing composition, suitable for use in various laundry applications, which provides improved fabric whiteness to fabrics treated therewith and which has, at the same time, a commercially acceptable chemical stability.

The Applicant has now surprisingly found that this problem can be solved by formulating a liquid hypohalite bleaching composition comprising, in addition to a brightener, a latex. Indeed, it has been found that the addition of latex, in a brightener and hypochlorite bleach-containing composition, delivers improved whitening performance as compared to the same composition without a latex. Moreover, it has been found that the brightener is chemically stable in hypochlorite-based compositions which contains a latex.

Moreover, the applicant has surprisingly found that overall the hypochlorite-based compositions which contain latex, as defined herein, has improved chemical stability. This stability is improved by comparison with the same composition which does not contain a latex but comprise brightener. Therefore, an advantage of the present invention is that chemically stable compositions are provided that are suitable to be used in the most efficient manner by the consumer over prolonged period of time. Indeed, the improved whitening action is maintained even for compositions having undergone long storage periods.

In a preferred embodiment, the compositions of the present invention further comprise a radical scavenger. Indeed, the addition of such a radical scavenger in a composition comprising a hypohalite bleach, brightener and latex, even further improves the brightener stability and the chemical stability of the composition upon ageing, i.e. upon prolonged periods of storage after its manufacturing.

In another preferred embodiment, the compositions of the present invention are opaque compositions.

An another advantage of the compositions of the present invention is that they allow to provide outstanding fabric whitening action without compromising on the stain removal performance on different types of stains including bleachable stains (e.g. coffee), enzymatic stains (e.g. blood) and greasy stains (e.g. food), clay/mud stains, and the like. More particularly, the compositions of the present invention are suitable for bleaching any type of fabrics including natural fabrics (e.g., fabrics made of cotton, nylon and linen), synthetic fabrics such as those made of polymeric fibers of synthetic origin as well as those made of both natural and synthetic fibers. Indeed, the compositions of the present invention may be used on synthetic fibers despite a standing prejudice against the use of hypohalite bleaches, especially hypochlorite bleaches, on synthetic fibers, as evidenced by warning on labels of commercially available hypochlorite bleaches and clothes.

Compositions comprising hypohalite and latex have been described in the art. U.S. Pat. No. 3,689,421 provides a liquid household bleach composition comprising an alkaline solution comprising hypochlorite ion and latex.

U.S. Pat. No. 3,655,566 provides a composition containing a hypochlorite ion and an optical brightener protectively carried in the solution by a styrene polymer carrier.

### SUMMARY OF THE INVENTION

The present invention encompasses a liquid bleaching composition comprising, a hypohalite bleach, a latex and a brightener. In a preferred embodiment, said composition is an opaque hypochlorite bleach-containing composition. In another preferred embodiment, the composition further comprises a radical scavenger.

The present invention further encompasses the use of a composition as defined herein, to improve the fabric whiteness performance of fabrics treated within.

### DETAILED DESCRIPTION OF THE INVENTION

The present invention encompasses a composition suitable for treating fabrics, comprising a hypohalite bleach, a latex and a brightener.

In a preferred embodiment, the composition of the present invention is an opaque hypochlorite bleach-containing composition. As used herein the term “opaque” indicates a composition that does not allow the light to pass through, which means that the composition is impenetrable to light, and thus it is not possible to see through. An opaque composition is neither transparent (allowing all light to pass through, thus it can be clearly seen through), nor translucent (allowing some light to pass through (diffusely), thus it can not be clearly seen through).

The bleaching compositions of the present invention are chemically and physically stable. By “chemically stable”, it is to be understood that the hypohalite bleaching compositions of the present invention typically do not undergo more than 25% loss of available chlorine after 5 days of storage at 50° C.±0.5° C. and more preferably not more than 15%. The percentage loss of available chlorine may be measured using the method described, for instance, in “Analyses des Eaux et Extraits de Javel” by “La chambre syndicate nationale de L'eau de Javel et des produits connexes”, pages 9-10 (1984). Said method consists in measuring the available chlorine in the fresh compositions, i.e. just after they are made, and in the same compositions after 5 days at 50° C. (rapid aging test). By “chemically stable” it is meant herein that the attack and/or oxidation by said hypohalite bleach on brightener, contained in the composition, is reduced, even absent. In other words, the concentration does not undergo more than 70% loss of brightener after 5 days at 50° C., preferably 60%, more preferably 50% (rapid aging test).

By “physically stable” it is meant herein that the compositions of the present invention do not split in two or more phases when exposed in stressed conditions, e.g. at a temperature of 50° C. during 5 days.

The compositions according to the present invention are formulated in a liquid form including gel and paste form. Preferred liquid bleaching compositions of the present invention are aqueous and therefore, preferably comprise water. More preferably the compositions according to the present invention comprise water in an amount of from 50% to 98%, even more preferably of from 60% to 95% and most preferably 80% to 90% by weight of the total composition.

The present invention is based on the finding that the addition of latex, in a liquid bleaching composition comprising a hypohalite bleach and a brightener, improves the chemical and physical stability of said composition upon prolonged periods of storage time, typically after 6 months of storage at room temperature (around 25° C.) after their manufacturing. Thus, the percentage loss of available chlorine decrease as compared to the same composition, but without any latex, resulting therefore in effective whiteness performance of the aged composition when used in any laundry application. Moreover, the addition of latex improve the chemical stability of the brightener of said composition resulting also in effective whiteness performance of the aged composition.

By “effective” whiteness performance, i.e. the yellowing-prevention effect, it is to be understood that the whitening performance delivered on fabrics bleached with a composition according to the present invention is improved, as compared to the whitening performance delivered by the same composition, but without any latex as mentioned herein. In other words, the present invention allows to maintain excellent whitening performance. These performances are even maintained after prolonged periods of storage time, typically after 6 months of storage at room temperature (around 25° C.) after their manufacturing. The degree of whiteness/yellowing can be determined by both visual and instrumental grading. Visually, the difference between items treated with different compositions can be determined by a team of expert panelists. Instrumentally, the assessment can be determined with the help of Colorimeters such as Ganz Griesser® instruments (e.g., Datacolor® Spectraflash® SF 500, Machbet White-eye® 500) or a ZEISS ELREPHO® or others which are available for instance from Hunterlab® or Gardner®.

Hypohalite Bleaches

As a first essential ingredient, the compositions of the present invention comprise a hypohalite bleach. Any hypohalite bleach known to those skilled in the art may be suitable for use herein.

Suitable hypohalite bleaches may be provided by a variety of sources, including bleaches that lead to the formation of positive halide ions and/or hypohalite ions, as well as bleaches that are organic based sources of halides, such as chloroisocyanurates.

Suitable hypohalite bleaches for use herein include the alkali metal and alkaline earth metal hypochlorites, hypobromites, hypoiodites, chlorinated trisodium phosphate dodecahydrates, potassium and sodium dichloroisocyanurates, potassium and sodium trichlorocyanurates, N-chloroimides, N-chloroamides, N-chloroamines and chlorohydantoins.

For the bleaching compositions herein, the preferred hypohalite bleaches among those described above are the alkali metal or alkaline earth metal hypochlorites selected from the group consisting of sodium, potassium, magnesium, lithium and calcium hypochlorites, and mixtures thereof. Sodium hypochlorite is the most preferred hypohalite bleach. Preferably the composition according to the invention will contains as hypohalite bleach an alkali metal sodium hypochlorite.

Preferably, the bleaching compositions according to the present invention may comprise said hypohalite bleach such that the content of active halide in the composition is from 0.01% to 20% by weight, preferably from 0.1% to 10%, even more preferably 0.5% to 6%, even more preferably 0.5% to 4.5% by weight of the liquid composition.

Latex

Another feature of the composition of the present invention is the presence of latex. The latex is defined herein as a water-based colloidal dispersion or colloidal suspension (depending on particle size) of water-insoluble polymer particles. Latex is also known as polymeric colloid.

An essential feature of said latex is that the polymers are not chemically bound to other chemical compounds such as for example the brightener; i.e. they are not copolymerized with those chemical compounds, in particular they are not copolymerized with brighteners.

The polymer particles of latex is chosen from the group of polymers comprising styrene-butadiene copolymers, butadiene-acrylonitrile copolymers, butadiene-styrene-acrylonitrile copolymers, chloroprene copolymers, methacrylate and acrylate ester copolymers, vinyl acetate copolymers, vinyl and vinylidene chloride copolymers, ethylene copolymers, fluorinated copolymers, acrylamide copolymers, styrene-acrolein copolymers, pyrrole and pyrrole copolymers and the likes. Preferably, the polymers used herein will be styrene copolymers, more preferably styrene-acrylate copolymers.

Latex which may be useful in the present invention can be a compound known as “Opacifier”. It is meant herein that said compound is added in the purpose of making the composition which contains it opaque. An example of this compound is commercially available from Rohm and Haas under the trade name Acusol OP301.

In a preferred embodiment, latex is incorporated at a level of from 0.01% to 1%, preferably from 0.01% to 0.5%, more preferably from 0.05% to 0.4%.

Brighteners

Another important feature of the composition of the present invention is the presence of a brightener. Any brightener known in the art may be used herein including both hydrophobic and hydrophilic brighteners and mixtures thereof. In a preferred embodiment, the brightener is hydrophilic.

When hydrophobic brighteners are present in the compositions herein they have to be solubilized or suspended in the compositions of the present invention. Such brighteners solubilisation can be for example achieved by means of the surfactants. Alternatively, the brightener may be suspended by means of a specific suspending agent, like polymers and/or colloidal particulate silicate.

In preferred embodiment, brightener is incorporated at a level of from 0.001% to 1.0%, preferably from 0.005% to 0.5%, more preferably from 0.005% to 0.3% and most preferably from 0.008% to 0.1%, by weight of the composition.

By “hydrophobic brighteners”, it is to be understood herein any brightener whose solubility in water is lower than 10 grams per liter at 25° C. By “solubility” of a given compound, it is to be understood herein the amount of said compound solubilized in deionized water at 25° C. Thus, a compound having a solubility being lower than 10 grams per liter means that when less than 10 grams of said given compound is incorporated in deionized water at 25° C. said compound is entirely dissolved in said water, i.e. a clear and stable solution is obtained. In other words, incorporating 10 grams per liter or more of said given compound in water will result in a precipitation of said compound in said medium. Accordingly, by “hydrophilic brighteners”, it is to be understood herein any brightener whose solubility in water is higher or equal to 10 grams per liter at 25° C.

Brighteners are compounds which have the ability to fluoresce by absorbing ultraviolet wave-lengths of light and re-emitting visible light. Brighteners, also referred to as fluorescent whitening agents (FWA), have been extensively described in the art, see for instance EP-A-0 265 041, EP-A-0 322 564, EP-A-0 317 979 or “Fluorescent whitening agents” by A. K. Sarkar, published by MERROW, especially page 71-72.

Commercial optical brighteners which may be useful in the present invention can be classified into subgroups, which include, but are not necessarily limited to, derivatives of stilbene, pyrazoline, coumarin, carboxylic acid, methinecyanine, dibenzothiophene-5,5-dioxide, azole, 5- and 6-membered-ring heterocycle, and other miscellaneous agents. Examples of such brighteners are disclosed in “The Production and Application of Fluorescent Brightening Agents”, M. Zahradnik, Published by John Wiley & Sons, New York (1982). Further optical brighteners which may also be used in the present invention include naphthlimide, benzoxazole, benzofuran, benzimidazole and any mixtures thereof. Particularly preferred brighteners for use herein are the derivatives of stilbene and mixtures thereof.

Examples of optical brighteners which are useful in the present compositions are those identified in U.S. Pat. No. 4,790,856. These brighteners include the PHORWHITE® series of brighteners from Verona. Other brighteners disclosed in this reference include: Tinopal-UNPA®, Tinopal CBS® and Tinopal 5BM® available from Ciba-Geigy; Artic White CC® and Artic White CWD®; the 2-(4-styryl-phenyl)-2H-naptho[1,2-d]triazoles; 4,4′-bis(1,2,3-triazol-2-yl)-stilbenes; 4,4′-bis(styryl)bisphenyls; and the aminocoumarins. Specific examples of brighteners useful herein include 4-methyl-7-diethyl-amino coumarin; 1,2-bis(-benzimidazol-2-yl)ethylene; 1,3-diphenyl-pyrazolines; 2,5-bis(benzoxazol-2-yl)thiophene; 2-styryl-naptho-[1,2-d]oxazole; 2-(stilbene-4-yl)-2H-naphtho[1,2-d]triazole, 3-phenyl-7-(isoindolinyl)coumarin; 3-methyl-7-(isoindolinyl)coumarin; 3-chloro-7-(isoindolinyl)coumarin; 4-(isoindolinyl)-4′-methylstilbene; 4-(isoindolinyl)-4′-methoxystilbene; sodium 4-(isoindolinyl)-4′-stilbenesulfonate; 4-(isoindolinyl)-4′-phenylstilbene; 4-(isoindolinyl)-3-methoxy-4′-methylstilbene; 4-(2-chloroisoindolinyl)-4′-(2-methylisoindolinyl)-2,2′-stilbenedisosulfonic acid; disodium 4,4′-diisoindolinyl-2,2′-stilbene disulfonate; 4,4′-diisoindolinyl-2,2′-stilbenedisulfonamide; disodium 4,4′-(7,8-dichloro-1-isoindolinyl)2,2-stilbenedisulfonate; disodium 4,4′-(7-chloro-1-isoindolinyl)2,2-stilbenedisulfonate; disodium 4,4′-(6-Isopropoxy-1-isoindolinyl)2,2-stilbenedisulfonate; disodium 4,4′-(7,8-diisopropyl-1-isoindolinyl)2,2-stilbenedisulfonate; disodium 4,4′-(7-butoxy-1-isoindolinyl)2,2-stilbenedisulfonate; disodium 4,4′-(6-trifluoromethyl-1-isoindolinyl)2,2-stilbenedisulfonate; disodium 4,4′-[6-(1,4,7-trioxanonyl)-1-isoindolinyl)]2,2-stilbenedisulfonate; disodium 4,4′-(7-methoxymethyl-1-isoindolinyl)2,2-stilbenedisulfonate; disodium 4,4′-(6-phenyl-1-isoindolinyl)2,2-stilbenedisulfonate; disodium 4,4′-(6-naphthyl-1-isoindolinyl)2,2-stilbenedisulfonate; disodium 4,4′-(6-methylsulfonyl-1-isoindolinyl)2,2-stilbenedisulfonate; disodium 4,4′-(7-cyano-1-isoindolinyl)2,2-stilbenedisulfonate; and disodium 4,4′-[7-(1,2,3-trihydroxypropyl)-1-isoindolinyl)]2,2-stilbenedisulfonate; disodium 4-isoindolinyl-4′-ethoxy-2,2′-stilbenedisulfonate; disodium 4-isoindolinyl-4′-methoxy-2,2′-stilbenedisulfonate; disodium 4-isoindolinyl-4′-ethoxy-2,2′-stilbenedisulfonamide; disodium 4-isoindolinyl-4′-methyl-2,2′-stilbenedisulfonamide; disodium 4,4′-bis-(2-diethanolamino-4-anilino-s-triazin-6-ylamino)stilbene-2:2 disulphon ate, disodium 4,4′-bis-(2-morpholino-4-anilino-s-triazin-6-ylamino)-stilbene-2:2′-disulphonate, disodium 4,4′-bis-(2,4-dianilino-s-triazin-6-ylamino)-stilbene-2-sulphonate, monosodium 4,4″-bis-(2,4-dianilino-s-triazin-6-ylamino)-stilbene-2:2′-disulphonate, disodium 4,4′-bis-(2-anilino-4-(N-methyl-N-2-hydroxyethylamino)-s-triazin-6-ylamino)stilbene-2,2′-disulphonate, disodium 4,4′-bis-(4-phenyl-2,1,3-triazol-2-yl)-stilbene-2,2′ disulphonate, disodium 4,4′-bis-(2-anilino-4-(1-methyl-2-hydroxyethylamino)-s-triazin-6-ylamino)-stilbene-2,2′-disulphonate, sodium 2-(stilbyl-4″-(naphtho-1′,2′:4,5)-1,2,3-triazole-2″-sulphonate, 4,4′-bis-(2-sulphostyryl)-biphenyl, 4,4′-bis(4-phenyl-2H-1,2,3-triazol-2-yl)-2,2′-stilbenedisulfonic acid and mixture thereof. See also U.S. Pat. No. 3,646,015, U.S. Pat. No. 3,346,502 and U.S. Pat. No. 3,393,153 for further examples of brighteners useful herein. More preferably, the brighteners useful herein is the 4,4′-bis-(2-sulphostyryl)-biphenyl.

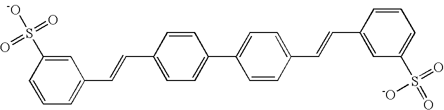

Indeed one of the functionally equivalent derivative salts of 4,4′-bis(4-phenyl-2H-1,2,3-triazol-2-yl)-2,2′-stilbenedisulfonic acid, namely its sodium salt is available from Mobay Chemical Corporation, a subsidiary of Bayer AG under the name Phorwite® CAN. The amine salt is available from Molay under the name Phorwite® CL solution. The potassium salt is available under the name Phorwite® BHC 766.

Specific examples of hydrophilic optical brighteners useful in the present invention are those having the structural formula:

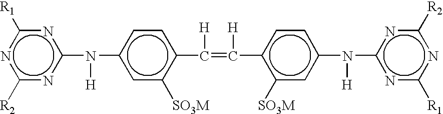

wherein R₁ is selected from anilino, N-2-bis-hydroxyethyl and NH-2-hydroxyethyl; R₂ is selected from N-2-bis-hydroxyethyl, N-2-hydroxyethyl-N-methylamino, morphilino, chloro and amino; and M is a salt-forming cation such as sodium or potassium. When in the above formula, R₁ is anilino, R₂ is N-2-bis-hydroxyethyl and M is a cation such as sodium, the brightener is 4,4′,-bis[(4-anilino-6-(N-2-bis-hydroxyethyl)-s-triazine-2-yl)amino]-2,2′-stilbenedisulfonic acid and disodium salt. This particular brightener species is commercially marketed under the tradename Tinopal-UNPA-GX by Ciba-Geigy Corporation. Tinopal-UNPA-GX is the preferred hydrophilic optical brightener useful in the detergent compositions herein.

When in the above formula, R₁ is anilino, R₂ is N-2-hydroxyethyl-N-2-methylamino and M is a cation such as sodium, the brightener is 4,4′-bis[(4-anilino-6-(N-2-hydroxyethyl-N-methylamino)-s-triazine-2-yl)amino]2,2′-stilbenedisulfonic acid disodium salt. This particular brightener species is commercially marketed under the tradename Tinopal 5BM-GX by Ciba-Geigy Corporation.

When in the above formula, R₁ is anilino, R₂ is morphilino and M is a cation such as sodium, the brightener is 4,4′-bis[(4-anilino-6-morphilino-s-triazine-2-yl)amino]2,2′-stilbenedisulfonic acid, sodium salt. This particular brightener species is commercially marketed under the tradename Tinopal AMS-GX by Ciba Geigy Corporation.

Another preferred brightener is Optiblanc BRB available from 3V sigma.

Other substituted stilbene 2,2′-disulfonic acid derivatives also include 4-4′-bis(2-2′ styryl sulfonate)biphenyl, commercially available from Ciba-Geigy under the trade name Tinopal CBS-(X).

Specific examples of hydrophobic brighteners useful in the present invention include the polycyclic oxazole derivatives such as benzo-oxazole derivatives, or mixtures thereof and particularly preferred herein the benzo-oxazole derivatives. An example of such a brightener is benzoxazole,2,2′-(thiophenaldyl)bis having the following formula C18H10N2O2S, commercially available from Ciba-Geigy under the trade name Tinopal SOP®. This brightener is almost insoluble in water, i.e. it has a solubility being lower than 1 gram per liter. Another example of such a brightener is bis(sulfobenzofuranyl)biphenyl, commercially available from Ciba-Geigy under the trade name Tinopal PLC®.

Radical Scavengers

In a preferred embodiment, the composition of the present invention will comprise a radical scavenger or a mixture thereof. Naturally, for the purpose of the present invention, the radical scavengers have to be stable to the hypohalite bleach. The compositions of the present invention comprise from 0.001% to 10% by weight of the total composition of a radical scavenger, or a mixture thereof, preferably from 0.01% to 2%, more preferably from 0.05% to 0.5% and most preferably from 0.1% to 0.2%.

By “radical scavenger” it mean herein any “chain breaking Antioxidant”, i.e. antioxidants which are able to interrupt the main oxidative cycle by removing the main propagating radicals (see definition in Mechanisms of Antioxidant Action and Stabilisation Technology, Sahar Al-Maliaka, Polymer Degradation Stability 34 (1991) 1-36).

Suitable radical scavengers for use herein include the well-known substituted mono and di hydroxy benzenes and derivatives thereof, alkyl- and aryl carboxylates and mixtures thereof. Preferred radical scavengers for use herein include di-tert-butyl hydroxy toluene, hydroquinone, di-tert-butyl hydroquinone, mono-tert-butyl hydroquinone, tert-butyl-hydroxy anysole, benzoic acid, toluic acid, catechol, t-butyl catechol, 2-methoxy-phenol, 2-ethoxy-phenol, 4-allyl-catechol, 2-methoxy-4-(2-propenyl)phenol, benzylamine, 1,1,3-tris(2-methyl-4-hydroxy-5-t-butylphenyl)butane, as well as n-propyl-gallate. Highly preferred for use herein is di-tert-butyl hydroxy toluene, which is for example commercially available from SHELL under the trade name IONOL CP®.

In another embodiment the suitable radical scavengers for use herein include also “aromatic radical scavenger”. Preferably, said radical scavenger is an aromatic radical scavenger or a mixture thereof, preferably a benzene derivative, naphthalene derivative, annulene derivative, cyclopentadiene derivative, cyclopropene derivative, aryl carboxylate, aryl sulfonate or a mixture thereof.

By “aromatic radical scavenger” it is meant herein an unsaturated mono- or poly-aromatic ring system comprising from 4 to 14 carbon atoms, preferably from 4 to 10 and more preferably from 4 to 6, and optionally one or more heteroatoms preferably selected from the group of nitrogen, oxygen, sulphur or mixtures thereof, and having a double bond set comprising a total of 4n+2 electrons, wherein n is an integer of from 1 to 3, preferably of from 1 to 2.

Suitable aromatic radical scavenger having only one —OH group directly linked on the aromatic ring herein include aromatic radical scavenger as defined herein before having only one substituent, i.e. a —OH group, as well as aromatic radical scavengers as defined herein before having several substituents, only one of them being an —OH group the other substituents being one of the following groups: linear alkyl chains as —(CH₂)ₙ—CH₃, secondary alkyl chains as —CHRR′, tertiary alkyl chains as —CRR′R″, alkyloxy groups as —O—R wherein R═—(CH₂)ₙ—CH₃, R′═—(CH₂)ₘ—CH₃ and R″═—(CH₂)ₚ—CH₃, and n, m and p are integer of from 0 to 4, primary (—NH₂), secondary (—NRH), and tertiary (—NR₂) aminic groups, aldehydic groups (—CHO), carboxylic groups (—COOH), sulphonic groups (—SO₃H) and substituted or unsubstituted phenilic groups.

Accordingly suitable aromatic radical scavengers having only one —OH group directly linked on the aromatic ring to be used herein include di-tert-butyl-hydroxy toluene (BHT), tert-butyl-hydroxy anysole, p-hydroxy-toluene, p-hydroxy-anysole, tert-butyl-hydroxy anyline and p-hydroxy anyline. Di-tert-butyl hydroxy toluene (BHT) is highly preferred herein and may be commercially available for example from SHELL under the name IONOL CP®.

Suitable aromatic radical scavenger having at least two —OH groups respectively disposed in para or ortho position herein include aromatic radical scavengers as defined herein before having only two substituents, i.e. two —OH groups, as well as aromatic radical scavengers as defined herein having more than two substituents, two of them being an —OH group the other substituents being any of the following groups: —OH, linear alkyl chains as —(CH₂)ₙ—CH₃, secondary alkyl chains as —CHRR′, tertiary alkyl chains as —CRR′R″, alkyloxy groups as —O—R wherein R═—(CH₂)ₙ—CH₃, R′═—(CH₂)ₘ—CH₃ and R″═—(CH₂)ₚ—CH₃, and n, m and p are integer of from 0 to 4, primary (—NH₂), secondary (—NRH), and tertiary (—NR₂) aminic groups, aldehydic groups (—CHO), carboxylic groups (—COOH), sulphonic groups (—SO₃H) and substituted or unsubstituted phenilic groups.

Suitable aromatic radical scavenger having at least two —OH groups respectively disposed in ortho or para position to be used herein include hydroquinone (HQ) and derivatives thereof, catechol and derivatives thereof or mixture thereof. Suitable derivatives of hydroquinone include di-tert-butyl hydroquinone (DTBHQ), monotert-butyl hydroquinone (MTBHQ), 2,5-dihydroxybenzoic acid, 2,5-dihydroxyterephtalic acid and di-alkyl hydroquinones sulphonated. Suitable derivatives of catechol include t-butyl catechol, 4-allyl catechol, 4-acetyl catechol, 3,4-dihydroxy benzaldehyde and 2,3-dihydroxy benzaldehyde.

Highly preferred aromatic radical scavengers having at least two —OH respectively disposed in ortho or para position are mono tert-butyl hydroquinone (MTBHQ), hydroquinone (HQ) and catechol or mixtures thereof. Mono tert-butyl hydroquinone (MTBHQ) may be commercially available for example from EASTMAN CHEMICAL under the name MTBHQ® and hydroquinone (HQ) may be commercially available for example from EASTMAN CHEMICAL under the name HQ®.

The radical scavenger suitable for use herein can also be selected from one or more of the categories as listed below. Hence, the radical scavenger may be selected from one category as listed below or may be a mixture of radical scavengers from one category or in fact may be a mixture of radical scavengers selected from more than one category. The radical scavengers of the present invention are described in four categories. The first category of radical scavengers (i) has general formula:

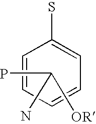

### Wherein S is either —COO⁻M⁺ or —SO₃⁻M⁺; P and N substituents of the benzene ring being either —OR′, —H, —COO⁻M⁺, —Cl, —Br, —SO₃⁻M⁺, —NO₂, —OCH₃, or a C₁ to C₁₀ primary and secondary alkyl groups; R′ is C2-20 linear or branched alkyl chain; M is either H or a metal.

The second category of radical scavengers (ii) has general formula

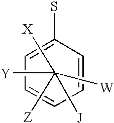

wherein S is either —COO⁻M⁺ or —SO₃⁻M⁺; X, Y, Z, W are substituents of the benzene ring being either —COO⁻M⁺, —Cl, —Br, —SO₃⁻M⁺, —NO₂, —OR′ (with R′=linear or branched alkyl chain C1-C20), or a C₁-C₁₀ primary and secondary alkyl groups; J is —H, —COO⁻M⁺, —Cl, —Br, —SO₃⁻M⁺, —NO₂, —OR′ (with R′=linear or branched alkyl chain C1-C20), or a C₁ to C₁₀ primary and secondary alkyl group and M is either H or a metal.

The third category of radical scavengers (iii) are naphtalene derivatives wherein the carbon atoms in position 1 to 8 (see below figure for carbon numbering) are substituted with S, A, B, C, D, E, F, G groups and wherein: S is either —COO⁻M⁺ or —SO₃⁻M⁺; A, B, C, D are —COO⁻M⁺, —Cl, —Br, —SO₃⁻M⁺, —NO₂, —OR′ (with R′=linear or branched alkyl chain C1-C20), or a C₁ to C₁₀ primary and secondary alkyl groups; E, F and G are either —H, —COO⁻M⁺, —Cl, —Br, —SO₃⁻M⁺, —NO₂, —OR′ (with R′=linear or branched alkyl chain C1-C20), or a C₁ to C₁₀ primary and secondary alkyl group and M is H or a metal.

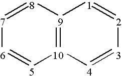

The forth category of radical scavengers (iv) are homo or copolymers containing either as a part of the repeating unit(s) or as a side chain substituent one or more residues of the type:

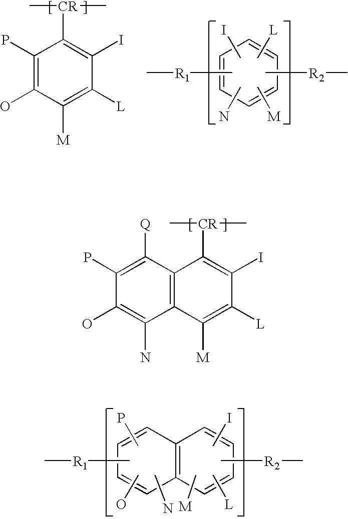

wherein I, L, M, N, O, P, Q are either H, —COO⁻M⁺, —SO₃⁻M⁺, —Cl, —Br, —SO₃⁻M⁺, —NO₂, —OR′ (with R′=linear or branched alkyl chain C1-C20) or a C₁-C₁₀ primary and secondary alkyl groups; R is either H, —COO⁻M⁺, —SO₃⁻M⁺, —Cl, —Br, —SO₃⁻M⁺, —NO₂, —OR′ (with R′=linear or branched alkyl chain C1-C20), —OH or a C₁-C₁₀ primary and secondary alkyl groups; R1 and R2 are either —CH₂—, —CHR—, —CRR—, —CO—, —CO—O—, —CO—NH—, —O—, —CH₂CH₂O—, —N⁺(R)₂—, —(N→O)— and M is either H or a metal.

Preferred radical scavengers are selected from the group consisting of 2,3,4,5 tetramethoxy benzoic acid; 2,3,4,5,6 pentamethoxy benzoic acid; polystyrene; polystyrene sulfonate; styrene:maleic acid copolymer; styrene:acrylic acid copolymer; styrene:ethylene glycole graft polymers; poly(ethyleneglycol)di-toluene sulfonate; poly hydroxy benzoic acid; poly hydroxy styrene; poly methyl stryrene; polystyrene divinyl benzene; poly vinyl phenol; and mixtures thereof.

In a more preferred embodiment, suitable radical scavengers for use herein will include aromatic radical scavengers comprising an unsaturated ring system of from 3 to 20 carbon atoms, preferably of from 3 to 18 and more preferably of from 5 to 14 and having a double bond set comprising a total of 4n+2 electrons, wherein n is an integer of from 0 to 4, preferably of from 1 to 3. Indeed said aromatic radical scavengers include benzene derivatives, naphthalene derivatives, annulene derivatives, cyclopentadiene derivatives, cyclopropene derivatives and the like, especially aryl carboxylates and/or aryl sulfonates. Particularly suitable radical scavengers (aryl carboxylates, aryl sulphonate and derivatives thereof) for use in the present invention have one of the following formulas:

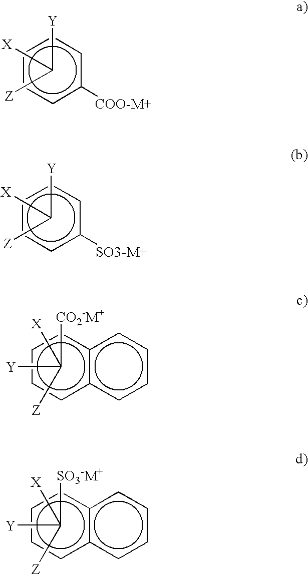

wherein each X, Y, and Z are —H, —COO—M⁺, —Cl, —Br, —SO₃⁻M⁺, —NO₂, —OCH₃, or a C₁ to C₁₀ primary and secondary alkyl groups and M is H or an alkali metal, or mixtures thereof. Examples of these components include pyromellitic acid, i.e. where X, Y and Z are —COO—H⁺; hemimellitic acid, trimellitic acid, i.e. where X and Y are —COO—H⁺ and Z is H. Preferred to be used in the present invention as radical scavengers are phthalic acid; sulfophthalic acid; other mono-substituted phthalic acids; di-substituted benzoic acids; alkyl-, chloro-, bromo-, sulfo-, nitro- and alkoxy-benzoic acids, i.e. where Y and Z are —H and X is a C₁ to C₁₀ primary and secondary alkyl groups, —Cl, —Br, —SO₃—H⁺, —NO₂, and —OCH₃ respectively and substituted sulfonic acids. Preferred examples of the radical scavengers useful in the present invention are benzoic acid, methoxy benzoic acid, 3-nitrobenzoic acid, 4-toluene sulfonic acid, 2 n-octyl benzoic acid, 2 n-octyl sulfonic acid, anisic acid or salts thereof or mixtures thereof. Highly preferred examples of radical scavengers herein are benzoic acid and/or methoxy benzoic acid and/or 3-nitro benzoic acid.

More preferably, suitable radical scavengers for use in the present invention is 3,4,5 trimethoxy benzoic acid and 3,5 dimethoxy benzoic acid.

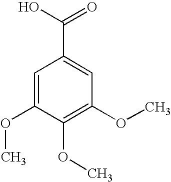

All the radical scavengers described above are the acidic form of the species, i.e. M is H. It is intended that the present invention also covers the salt derivatives of these species, i.e. M is an alkali metal, preferably sodium or potassium. In fact, since the pH of the compositions of the present invention is in the alkaline range, the radical scavengers of the present invention exist primarily as the ionized salt in the aqueous composition herein. The anhydrous derivatives of certain species described herein above can also be used in the present invention, e.g. pyromellitic dianhydride, phthalic anhydride, sulphthalic anhydride and the like.

Even more preferably, suitable radical scavengers for use in the present invention include a cyclic hindered amine. Preferably, the cyclic hindered amine has the general formula:

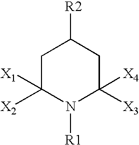

wherein X1, X2, X3 and X4, independently or all together, represent methyl or ethyl; R1 is H, methyl, ethyl, oxyl, hydroxyl or alkoxy group; and R2 is H, hydroxyl, alkoxy or oxycarbonyl.

In the context of the present invention, cyclic hindered amines are also referred to as cyclic hindered hydroxyl amines or cyclic hindered nitroxyl compounds.

In a preferred embodiment, X2, X3 and X4 are identical and are typically selected to be methyl. R1 is typically selected from the group of oxyl and hydroxyl. Preferably, R1 represents oxyl group. R2 is typically selected from the group of hydroxyl, alkoxy and oxycarbonyl. In a preferred execution, R2 is preferably selected to be hydroxyl.

Preferably, said cyclic hindered amine is selected from the group consisting of 4-hydroxy-2,2,6,6-tetramethylpiperidine; 4-methoxy-2,2,6,6-tetramethylpiperidine; 4-ethoxy-2,2,6,6-tetramethylpiperidine; 4-propoxy-2,2,6,6-tetramethylpiperidine 1-hydroxy-2,2,6,6,-tetramethyl-4-hydroxypiperidine; 1-hydroxy-2,2,6,6,-tetramethyl-4-methoxypiperidine; 1-hydroxy-2,2,6,6,-tetramethyl-4-ethoxypiperidine; 1-hydroxy-2,2,6,6,-tetramethyl-4-propoxypiperidine; bis(1-hydroxy-2,2,6,6-tetramethylpiperidin-4-yl)sebacate; 1-oxyl-2,2,6,6,-tetramethylpiperidine; 1-oxyl-2,2,6,6-tetramethyl-4-hydroxypiperidine; 1-oxyl-2,2,6,6-tetramethyl-4-hydroxypiperidine acetate; 1-oxyl-2,2,6,6-tetramethyl-4-hydroxypiperidine propanoate; 1-oxyl-2,2,6,6-tetramethyl-4-hydroxypiperidine butyrate; 1-oxyl-2,2,6,6-tetramethyl-4-hydroxypiperidine pentanoate; 1-oxyl-2,2,6,6-tetramethyl-4-hydroxypiperidine hexanoate; 1-oxyl-2,2,6,6-tetramethyl-4-hydroxypiperidine heptanoate; 1-oxyl-2,2,6,6-tetramethyl-4-hydroxypiperidine octanoate; 1-oxyl-2,2,6,6-tetramethyl-4-hydroxypiperidine nonanoate; 1-oxyl-2,2,6,6-tetramethyl-4-hydroxypiperidine decanoate; 1-oxyl-2,2,6,6-tetramethyl-4-hydroxypiperidine undecanoate; 1-oxyl-2,2,6,6-tetramethyl-4-hydroxypiperidine dodecanoate; bis(1-oxyl-2,2,6,6-tetramethylpiperidin-4-yl)propandioate; bis(1-oxyl-2,2,6,6-tetramethylpiperidin-4-yl)butandioate; bis(1-oxyl-2,2,6,6-tetramethylpiperidin-4-yl)pentandioate; bis(1-oxyl-2,2,6,6-tetramethylpiperidin-4-yl)hexandioate; bis(1-oxyl-2,2,6,6-tetramethylpiperidin-4-yl)heptandioate; bis(1-oxyl-2,2,6,6-tetramethylpiperidin-4-yl)octandioate; bis(1-oxyl-2,2,6,6-tetramethylpiperidin-4-yl)nonandioate; bis(1-oxyl-2,2,6,6-tetramethylpiperidin-4-yl)sebacate; bis(1-oxyl-2,2,6,6-tetramethylpiperidin-4-yl)dodecandioate; 1-oxyl-2,2,6,6-tetramethyl-4-methoxypiperidine; 1-oxyl-2,2,6,6-tetramethyl-4-ethoxypiperidine; 1-oxyl-2,2,6,6-tetramethyl-4-propoxypiperidine and a mixture thereof.

In a preferred execution, said cyclic hindered amine is selected from the group consisting of 4-hydroxy-2,2,6,6-tetramethylpiperidine; 1-hydroxy-2,2,6,6-tetramethyl-4-hydroxypiperidine; 1-oxyl-2,2,6,6,-tetramethylpiperidine; 1-oxyl-2,2,6,6-tetramethyl-4-hydroxypiperidine.

In a highly preferred embodiment, said cyclic hindered amine is 1-oxyl-2,2,6,6,-tetramethyl-4-hydroxypiperidine ( i.e. X1, X2, X3 and X4 are methyl; R1 is oxyl and R2 is hydroxyl). Suitable 4-hydroxy-2,2,6,6,-tetramethyl-piperidinyloxy is commercially available from 3V Sigma under tradename Tempoxy LO®, from Aldrich or from Lancaster under the trade name 4-hydroxy-TEMPO.

Anti-Resoiling Polymers:

The compositions may comprise as a highly preferred, but optional ingredient, an anti-resoiling polymer.

Suitable anti-resoiling polymers include soil suspending polyamine polymers. Any soil suspending polyamine polymer known to those skilled in the art may also be used herein. Particularly suitable polyamine polymers for use herein are alkoxylated polyamines. Such materials can conveniently be represented as molecules of the empirical structures with repeating units:

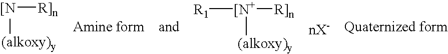

wherein R is a hydrocarbyl group, usually of 2-6 carbon atoms; R₁ may be a C₁-C₂₀ hydrocarbon; the alkoxy groups are ethoxy, propoxy, and the like, and y is from 2 to 30, most preferably from 7 to 20; n is an integer of at least 2, preferably from 2 to 40, most preferably from 2 to 5; and X— is an anion such as halide or methylsulfate, resulting from the quaternization reaction.

Highly preferred polyamines for use herein are the so-called ethoxylated polyethylene amines, i.e., the polymerized reaction product of ethylene oxide with ethyleneimine, having the general formula:

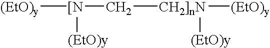

wherein y is from 2 to 50, preferably from 5 to 30, and n is from 1 to 40, preferably from 2 to 40. Particularly preferred for use herein is an ethoxylated polyethylene amine, in particular an ethoxylated polyethylene amine wherein n=2 and y=20, and an ethoxylated polyethylene amine wherein n=40 and y=7. Suitable ethoxylated polyethylene amines are commercially available from Nippon Shokubai CO., LTD or from BASF.

Furthermore, highly preferred polyamines for use herein are the so-called ethoxylated polyethylene quaternized amines having the general formula:

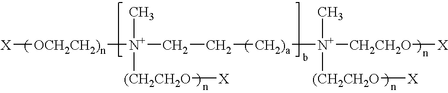

wherein X can be selected from hydrogen (H), C₁-C₄ alkyl or hydroxyalkyl ester or ether groups, SO₃⁻ or mixtures thereof. Preferred esters or ethers are the acetate ester and methyl ether, respectively. The particularly preferred nonionic groups are H and the methyl ether. The particularly preferred group is SO₃⁻; and wherein n is usually from 3 to 100, a is from 0 to 4 (e.g. ethylene, propylene, hexamethylene), b is 1. For preferred cationic diamines, n is at least 12 with a typical range of from 12 to 42.

Preferably the anti-resoiling polymers is an ethoxylated diamine. In a preferred embodiment, the anti-resoiling agent is an ethoxylated cationic diamine, more preferably the anti-resoiling agent is a sulphated ethoxylated zwiterrionic diamine. In a even more preferred embodiment, the anti-resoiling agent is a 24-Ethoxylated Hexarhethylene Diamine Quaternized; more preferably, the anti-resoiling agent is a trans-sulphated 24-Ethoxylated Hexamethylene Diamine Quaternized.

pH

The pH of the liquid compositions according to the present invention, as is, is typically from 8 to 14, preferably from 8.5 to 14, more preferably from 9 to 13.5, and even more preferably from 9.5 to 13.5, measured at 25° C. During the bleaching process, e.g., at a dilution level of 200:1 (water:composition), the liquid compositions of the invention may have a pH of at least 8, preferably at least 8.5, more preferably at least 9.5 for a longer period of time. It is in this alkaline range that the optimum stability and performance of the hypohalite bleach are obtained. The pH range is suitably provided by a pH buffering component if present and the hypohalite bleach mentioned hereinbefore, which are alkalis. However, in addition to these components, an alkalinity source may also optionally be used.

Suitable alkalinity sources for use herein are the caustic alkalis, such as sodium hydroxide, potassium hydroxide and/or lithium hydroxide, and/or the alkali metal oxides such, as sodium and/or potassium oxide or mixtures thereof. A preferred alkalinity source is a caustic alkali, more preferably sodium hydroxide and/or potassium hydroxide.

Preferred bleaching compositions herein may comprise up to 10%, preferably from 0.04% to 5% and more preferably from 0.1% to 2% by weight of the total composition of said alkalinity source.

Optional Ingredients

The bleaching compositions according to the present invention may further comprise optional ingredients, such as pH buffering components, bleach-stable surfactants, thickening agents, builders, pigments, solvents, stabilizing agents, hydrotropes, perfumes, and mixtures thereof.

The bleaching compositions according to the present invention may optionally comprise a pH buffering component. Particularly useful are alkali metal salts of carbonates, polycarbonates, sesquicarbonates, silicates, polysilicates, phosphonates, stannates, alluminates or mixtures thereof. The preferred alkali metal salts to be used herein are sodium and potassium salts. Particularly preferred are alkali metal salts of carbonate. The preferred alkali metal salt of carbonate is sodium carbonate.

The pH buffering components provide a prolonged through-the-bleach buffering action, i.e., maintain the pH of the bleaching solution at a pH of at least 8, preferably at least 8.5, more preferably at least 9.5 for a longer period of time, throughout the bleaching process, e.g., at a dilution level of 200:1 (water:composition), as compared to the buffering action obtained with the same composition without said pH buffering components.

The bleaching compositions of the present invention may comprise up to 10%, preferably from 0.01% to 5% and more preferably from 0.02% to 3% by weight of the total composition of a pH buffering component.

Accordingly, the compositions of the present invention may preferably comprise a surfactant or mixtures thereof as a preferred optional ingredient. Any surfactant known to those skilled in the art may be suitable herein including nonionic, anionic, cationic, zwitterionic, and/or amphoteric surfactants up to 50% by weight of the total composition. Surfactants allow to further improve the stain removal properties of the compositions according to the present invention. Nonionic surfactants are highly preferred herein for performance reasons. The liquid compositions herein may comprise up to 50% of a nonionic surfactant or mixtures thereof, preferably from 0.3% to 30% and more preferably from 0.4% to 25%. Suitable nonionic surfactants to be used are described in EP 0 839 903 B1 (page 19 line 28 to page 21 line 48).

The compositions may comprise a chelating agent as a preferred optional ingredient. Suitable chelating agents to be used herein include chelating agents selected from the group of phosphonate chelating agents, amino carboxylate chelating agents, polyfunctionally-substituted aromatic chelating agents, and further chelating agents like glycine, salicylic acid, aspartic acid, glutamic acid, malonic acid, or mixtures thereof. Chelating agents when used, are typically present herein in amounts ranging from 0.001% to 5% by weight of the total composition and preferably from 0.05% to 2% by weight. Suitable chelating agents to be used are described in EP 0 839 903 B1 (page 22 line 58 to page 23 line 47).

Process of Treating Surfaces:

The present invention also encompasses a process of treating a fabric. In such a process a composition according to the present invention is contacted with the fabrics to be treated. By “fabrics”, it is to be understood any types of fabrics including for example clothes, curtains, drapes, bed linens, bath linens, table cloths, sleeping bags, tents, upholstered furniture and the like. The process of bleaching fabrics herein is suitable for both natural fabrics and synthetic fabrics. By “natural” fabrics, it is meant fabrics made of cotton, viscose or linen. By “synthetic” fabrics, it is meant those made of synthetic fibers like polymeric fibers (polyamide, polyester, Lycra® and elasthane®), and those made of both natural and synthetic fibers.

This can be done either in a so-called “pretreatment mode”, where a liquid bleaching composition, as defined herein, is applied neat onto said fabrics before the fabrics are rinsed, or washed then rinsed, or in a “soaking mode” where a liquid bleaching composition, as defined herein, is first diluted in an aqueous bath and the fabrics are immersed and soaked in the bath, before they are rinsed, or in a “through the wash mode”, where a liquid bleaching composition, as defined herein, is added on top of a wash liquor formed by dissolution or dispersion of a typical laundry detergent. It is also essential in both cases, that the fabrics be rinsed after they have been contacted with said composition, before said composition has completely dried off.

The compositions according to the present invention are preferably contacted to fabrics in a liquid form. Indeed, by “in a liquid form”, it is meant herein the liquid compositions according to the present invention per se in neat or diluted form.

The compositions according to the present invention are typically used in diluted form in a laundry operation. By “in diluted form”, it is meant herein that the compositions for the bleaching of fabrics according to the present invention may be diluted by the user, preferably with water. Such dilution may occur for instance in hand laundry applications as well as by other means such as in a washing machine. Said compositions can be diluted up to 500 times, preferably from 5 to 200 times and more preferably from 10 to 150 times.

By “in its neat form”, it is to be understood that the compositions described herein are applied onto the fabrics to be treated without undergoing any dilution prior the application by the user.

By “washing”, it is to be understood herein that the fabrics are contacted with a conventional detergent composition, preferably comprising at least one surface active agent in an aqueous bath, this washing may occur by means of a washing machine or simply by hands. In a preferred embodiment, the washing step according to the present invention is performed in a washing machine. The conventional laundry detergent may be delivered into the washing machine either by charging the dispenser drawer of the washing machine with the detergent or by directly charging the drum of the washing machine with the detergent. By “conventional laundry detergent” it is meant herein, a laundry detergent composition currently available on the market. Preferably, said conventional laundry detergent comprises at least one surface active agent (“surfactant” as described herein below). Said laundry detergent compositions may be formulated as powders, liquids or tablets. Suitable laundry detergent compositions are for example DASH futur®, DASH essential®, DASH liquid®, ARIEL tablets® and other products sold under the trade names ARIEL® or TIDE®.

More specifically, the process of bleaching fabrics according to the present invention comprises the steps of first contacting said fabrics with a liquid bleaching composition as described herein, in its diluted form, then allowing said fabrics to remain in contact with said composition, for a period of time sufficient to bleach said fabrics, typically 1 to 60 minutes, preferably 5 to 45 minutes, then rinsing said fabrics in water. If said fabrics are to be washed, said washing may be conducted together with the bleaching of said fabrics by contacting said fabrics at the same time with a bleaching composition according to the present invention and said detergent composition, or said washing may be conducted before or after that said fabrics have been bleached. Accordingly, the process according to the present invention allows to bleach fabrics and optionally to wash fabrics before the step of contacting said fabrics with the liquid bleaching composition as described herein and/or in the step where said fabrics are contacted with the bleaching composition and/or after the step where said fabrics are contacted with the bleaching composition and before the rinsing step, and/or after the rinsing step.

In another embodiment of the present invention the process of bleaching fabrics comprises the step of contacting fabrics with a liquid bleaching composition according to the present invention, in its neat form, of allowing said fabrics to remain in contact with said bleaching composition for a period of time sufficient to bleach said fabrics, typically 5 seconds to 30 minutes, preferably 1 minute to 10 minutes and then rinsing said fabrics with water. If said fabrics are to be washed, said washing may be conducted before or after that said fabrics have been bleached. In the embodiment of the present invention wherein the liquid bleaching composition of the present invention, is contacted to the fabrics in its neat form, it is preferred that the level of hypohalite bleach, is from 0.01% to 5%, preferably from 0.1% to 3.5%, more preferably from 0.2% to 2% and most preferably from 0.2% to 1%. Advantageously, the present invention provides liquid hypohalite bleach-containing compositions that may be applied neat onto a fabric to bleach, despite a standing prejudice against using hypochlorite-containing compositions neat on fabrics. It is preferred to perform the bleaching processes herein before said fabrics are washed. Alternatively, instead of following the neat bleaching process as described herein above (pretreater application) by a rinsing step with water and/or a conventional washing step, the bleaching pre-treatment operation may also be followed by the diluted bleaching process as described herein before either in bucket (hand operation) or in a washing machine.

The temperatures at which the bleaching process herein is performed, do have an influence on the stain removal performance delivered. More specifically, an increased temperature accelerates the bleaching process, i.e. diminishes the time required to bleach a given soil. Typically, the bleaching solutions occurring in the bleaching processes according to the present invention where the bleaching compositions herein are used in their diluted form have a temperature of from 4° C. to 60° C, preferably from 10° C. to 50° C. and most preferably from 5° C. to 30° C.

In another embodiment the present invention also encompasses a process of treating a hard-surface, as the inanimate surface. In this specific case, the bleaching composition of the present invention is used by applying the liquid composition to the surface to be treated.

By “treating a surface”, it is meant herein bleaching and/or disinfecting said surfaces as the compositions of the present invention comprise a bleach.

Thus, the present invention also encompasses a process of treating (e.g., bleaching) a fabric, as the inanimate surface.

By “surfaces”, it is meant herein any inanimate surface. These inanimate surfaces include, but are not limited to, hard-surfaces typically found in houses like kitchens, bathrooms, or in car interiors, e.g., tiles, walls, floors, chrome, glass, smooth vinyl, any plastic, plastified wood, table top, sinks, cooker tops, dishes, sanitary fittings such as sinks, showers, shower curtains, wash basins, WCs and the like, as well as fabrics including clothes, curtains, drapes, bed linens, bath linens, table cloths and the likes. Inanimate surfaces also include household appliances including, but not limited to, refrigerators, freezers, washing machines, automatic dryers, ovens, microwave ovens, dishwashers and so on.

In such a process a composition, as defined herein, is contacted with the hard-surfaces to be treated. The process of treating a hard-surface with a composition, as defined herein, comprises the step of applying said composition to said hard-surface, and optionally rinsing said hard-surface.

In the process of treating hard-surfaces according to the present invention the composition, as defined herein, may be applied to the surface to be treated in its neat form or may be applied at a dilution level of up to 200:1 (solvent:composition), preferably from 2:1 to 80:1 and more preferably from 2:1 to 60:1 (solvent:composition), preferably using water as the solvent.

When used as hard-surfaces bleaching/disinfecting compositions the compositions of the present invention are easy to rinse and provide good shine characteristics on the treated surfaces.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid bleaching composition comprising a hypohalite bleach, a brightener and a latex.

2. A composition according to claim 1 wherein said composition comprises an opaque hypochlorite bleach-containing composition.

3. A composition according to claim 1 wherein said hypohalite bleach comprises an alkali metal sodium hypochlorite.

4. A composition according to claim 1 wherein said hypohalite, based on active halide, is present in an amount of from about 0.01% to about 20% by weight by weight of the liquid composition.

5. A composition according to claim 1 wherein said hypohalite, based on active halide, is present in an amount of from about 0.5% to about 6% by weight of the liquid composition.

6. A composition according to claim 1 wherein said hypohalite, based on active halide, is present in an amount of from about 0.5% to about 4.5% by weight of the liquid composition.

7. A composition according to claim 1 wherein the latex comprises a water-based colloidal dispersion or colloidal suspension of water-insoluble polymer particles wherein the polymer is selected chosen the group consisting of styrene-butadiene copolymers, butadiene-acrylonitrile copolymers, butadiene-styrene-acrylonitrile copolymers, chloroprene copolymers, methacrylate and acrylate ester copolymers, vinyl acetate copolymers, vinyl and vinylidene chloride copolymers, ethylene copolymers, fluorinated copolymers, acrylamide copolymers, styrene-acrolein copolymers, pyrrole and pyrrole copolymers and and mixtures thereof.

8. A composition according to claim 1 wherein the latex comprises a water-based colloidal dispersion or colloidal suspension of water-insoluble styrene-acrylate copolymers.

9. A composition according to claim 1 wherein the latex is present in an amount of from about 0.01% to about 1% by weight of the total liquid composition.

10. A composition according to claim 1 wherein the latex is present in an amount of from about 0.05% to about 0.4% by weight of the total liquid composition.

11. A composition according to claim 1 wherein the brightener comprises a derivative of stilbene, pyrazoline, coumarin, carboxylic acid, methinecyanine, dibenzothiophene-5,5-dioxide, azole, 5- or 6-membered-ring heterocycle, naphthlimide, benzoxazole, benzofuran, benzimidazole and mixtures thereof.

12. A composition according to claim 1 wherein the brightener comprises a derivative of stilbene.

13. A composition according to claim 1 wherein the brightener, or mixture thereof, is present in an amount of from about 0.005% to about 0.5% by weight of the total liquid composition.

14. A composition according to claim 1 wherein the brightener, or mixture thereof, is present in an amount of from about 0.008% to about 0.1% by weight of the total liquid composition.

15. A composition according to claim 1 wherein said composition comprises a radical scavenger.

16. A composition according to claim 15 wherein said radical scavenger comprises an aromatic radical scavenger.

17. A composition according to claim 15 wherein said radical scavenger comprises a benzene derivative, naphthalene derivative, annulene derivative, cyclopentadiene derivative, cyclopropene derivative, aryl carboxylate, aryl sulfonate or a mixture thereof.

18. A composition according claim 15 wherein said radical scavenger has one of the following formulas: 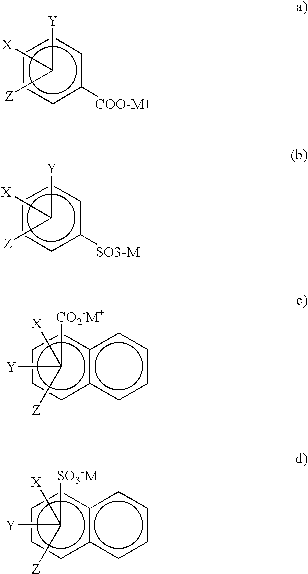
wherein each X, Y, and Z are —H, —COO—M⁺, —Cl, —Br, —SO₃—M^{+—, —NO}₂, —OCH₃, or a C₁ to C₁₀ primary and secondary alkyl groups and M is H or an alkali metal, or mixtures thereof.

19. A composition according claim 15 wherein said radical scavenger comprises phthalic acid; sulfophthalic acid; other mono-substituted phthalic acids; di-substituted benzoic acids; an alkyl-, chloro-, bromo-, sulfo-, nitro- or alkoxy-benzoic acid, i.e. where Y and Z are —H and X is a C1 to C10 primary and secondary alkyl groups, —Cl, —Br, —SO3-H+, —NO2, or —OCH3 respectively or a substituted sulfonic acid.

20. A composition according claim 15 wherein said radical scavenger comprises benzoic acid, methoxy benzoic acid, 4-toluene sulfonic acid, 2 n-octyl benzoic acid, 3-nitro benzoic acid, 2 n-octyl sulfonic acid, anisic acid or mixtures thereof.

21. A composition according to claim 15, wherein the radical scavenger comprises 3,4,5 trimethoxy benzoic acid or 3,5 dimethoxy benzoic acid.

22. A composition according to claim 15, wherein the radical scavenger, or mixture thereof, is present in an amount of from about 0.001% to about 10% by weight of the total liquid composition.

23. A composition according to claim 15 wherein the radical scavenger, or mixture thereof, is present in an amount of from about 0.01% to about 2% by weight of the total liquid composition.

24. A composition according to claim 15 wherein the radical scavenger, or mixture thereof, is present in an amount of from about 0.1% to about 0.2% by weight of the total liquid composition.

25. A composition according to claim 1 comprising an optional ingredient selected from the group consisting of anti-resoiling polymers, pH buffering components, bleach-stable surfactants, thickening agents, builders, pigments, solvents, stabilizing agents, hydrotropes, perfumes, and mixtures thereof.

26. A process of bleaching a fabric, with a liquid aqueous composition according to claim 1, said process comprising the steps of applying said composition, in its neat form or in its diluted form, onto at least a portion of said fabric, for a period of time sufficient to bleach said fabric, before said fabric is washed and/or rinsed.

27. A process according to the claim 26 wherein said fabrics are washed before the step of contacting said fabrics with said bleaching composition, and/or in the step where said fabrics are contacted with said bleaching composition, and/or after the rinsing step when said bleaching composition has been removed.
